(19) United States
(12) Patent Application Publication
(10) Pub. No.: US 2007/0165840 A1
(43) Pub. Date: Jul. 19, 2007

(54) Fastening mechanism for communication device

(76) Inventor: Hsi-Fan Chang, Banciao City (TW)

Correspondence Address: TROXELL LAW OFFICE PLLC;SUITE 1404, 5205 LEESBURG PIKE, FALLS CHURCH, VA, 22041, US

(21) Appl. No.: 11/326,496

(22) Filed: Jan. 6, 2006

(51) Int. Cl. H04M 1/00

(52) U.S. Cl. 379/441

(57) ABSTRACT

A fastening mechanism formed on a rear of a box-shaped communication device includes upper and lower openings, and upper and lower latches each extended from an edge of the opening and substantially covered the opening, the latch having a hole therethrough. Inserting either bar projected from a member into the hole and lifting the communication device to flexibly deform the latches will secure the communication device to the member. There are further provided two positioning blocks formed on an inner surface of the communication device abutted two upper corners of the upper latch, another two positioning blocks formed on the inner surface of the communication device abutted two lower corners of the lower latch, and two lateral grooves formed within the communication device for permitting the positioning blocks to urge thereon.

### BACKGROUND OF THE INVENTION

1) Field of Invention

The present invention relates to fastening mechanisms and more particularly to an improved snap-in fastening mechanism formed in a box-shaped communication device.

2) Related Art

A communication device 1 provided with a conventional fastening mechanism is shown in FIGS. 1 and 2. The communication device 1 is a parallelepiped housing and comprises on its rear surface upper and lower openings 2, and upper and lower double-sided adhesives 3 disposed transversely. In a mounting operation of the communication device 1, for example, mounting on a wall or a flat surface of a device, each of two bars 4 is inserted into the opening 2. Further, the adhesives 3 are adhered to the wall or the surface for securing the communication device 1 thereto.

However, the prior technique suffered from several disadvantages. For example, forming the double-sided adhesives 3 on the rear surface of the communication device 1 involves complicated processes, resulting in an increase in the manufacturing cost. Further, the double-sided adhesives 3 are susceptible to losing its adhesiveness as time passes. As an end, the communication device 1 may loosen or even fall to the ground. Thus, a need for improvement exists.

### SUMMARY OF THE INVENTION

It is therefore an object of the present invention to provide a fastening mechanism formed on a rear of a box-shaped communication device comprising upper and lower openings; and upper and lower latches each extended from an edge of the opening and substantially covered the opening, the latch having a hole therethrough; whereby inserting either bar projected from a member into the hole and lifting the communication device to flexibly deform the latches will secure the communication device to the member.

In one aspect of the present invention each of the openings is a rectangle.

In another aspect of the present invention there are further provided two positioning blocks formed on an inner surface of the communication device abutted two upper corners of the upper latch, another two positioning blocks formed on the inner surface of the communication device abutted two lower corners of the lower latch, and two lateral grooves formed within the communication device for permitting the positioning blocks to urge thereon.

The above and other objects, features and advantages of the present invention will become apparent from the following detailed description taken with the accompanying drawings.

### BRIEF DESCRIPTION OF THE DRAWINGS

FIG. 1 is a perspective view of a communication device having a prior fastening mechanism;

FIG. 2 is a side view in part broken away of the communication device of FIG. 1;

FIG. 3 is a perspective view of a communication device incorporating a fastening mechanism according to the invention;

FIG. 4 is a broken-away perspective view of the communication device of FIG. 3;

FIG. 5 is a cross-sectional view of the communication device being mounted on a device; and

FIG. 6 is a view similar to FIG. 5 where the communication device has been mounted securely.

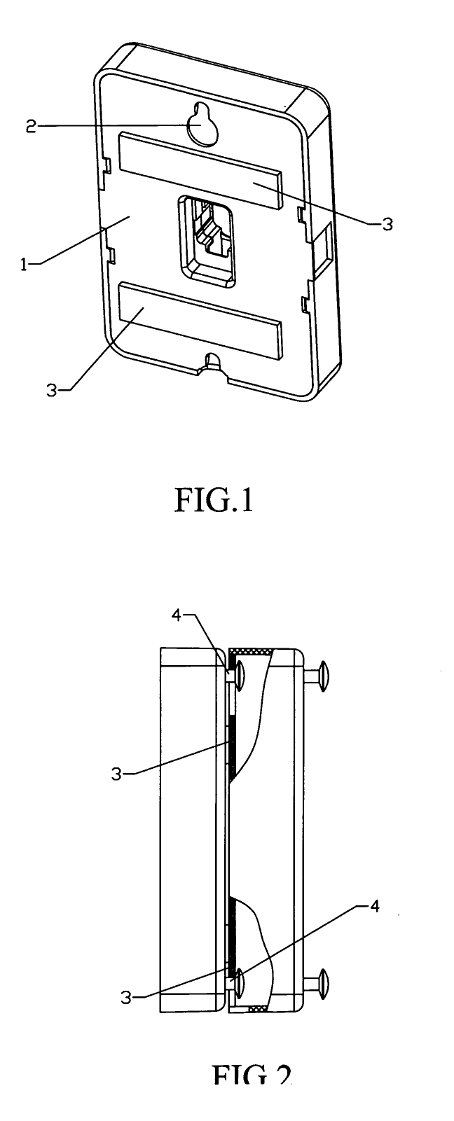

### DETAILED DESCRIPTION OF THE INVENTION

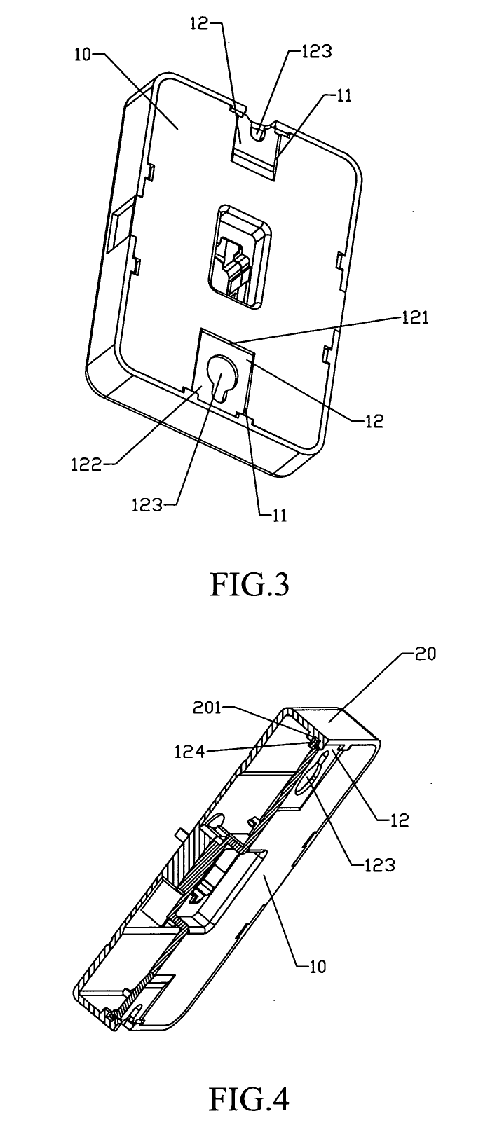

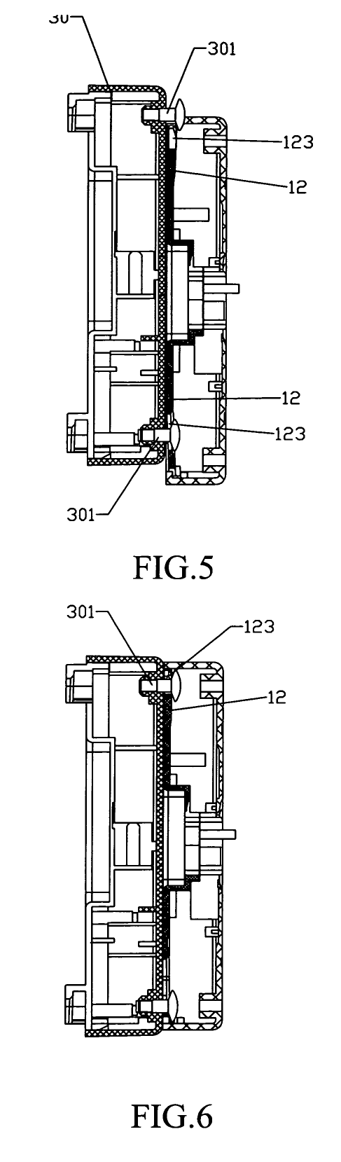

Referring to FIGS. 3 to 6, a communication device 10 in accordance with a preferred embodiment of the invention is shown. The communication device 10 is a parallelepiped housing 20 and comprises on its rear upper and lower rectangular openings 11, two resilient members 12 each having a joining portion 121 formed with an upper edge of the opening 11, and a latch 122 substantially covered the opening 11, the latch 122 having a hole 123 therethrough. Moreover, two positioning blocks 124 are formed on an inner surface of the communication device 10 abutted two upper corners of the upper latch 122 and another two positioning blocks 124 are formed on the inner surface of the communication device 10 abutted two lower corners of the lower latch 122. Further, two lateral grooves 201 are formed within the housing 20 for permitting the positioning blocks 124 to urge thereon. The provision of the positioning blocks 124 and the grooves 201 is to prevent the resilient members 12 from being damaged either in a fastening operation of the communication device 10 onto a wall or a flat surface of a device or in an unfastening operation of the same.

In a mounting operation of the communication device 10, for example, mounting on a flat surface of a device, either bar 301 of the device 30 is inserted into the hole 123. Next, lift the communication device 10 to flexibly deform the resilient members 12 so as to urge the positioning blocks 124 against the grooves 124. This can prevent the resilient members 12 from being damaged. Moreover, the stored elastic force of the resilient members 12 forces the bars 301 to securely engage with the holes 123. As a result, the communication device 10 is fastened. For unfastening the communication device 10, the steps discussed above are traversed in the opposite direction.

While the invention herein disclosed has been described by means of specific embodiments, numerous modifications and variations could be made thereto by those skilled in the art without departing from the scope and spirit of the invention set forth in the claims.

What is claimed is:

1. A fastening mechanism formed on a rear of a box-shaped communication device comprising:
upper and lower openings; and
upper and lower latches each extended from an edge of the opening and substantially covered the opening, the latch having a hole therethrough;
whereby inserting either bar projected from a member into the hole and lifting the communication device to flexibly deform the latches will secure the communication device to the member.

2. The fastening mechanism of claim 1, wherein each of the openings is a rectangle.

3. The fastening mechanism of claim 1, further comprising two positioning blocks formed on an inner surface of the communication device abutted two upper corners of the upper latch and another two positioning blocks formed on the inner surface of the communication device abutted two lower corners of the lower latch.

4. The fastening mechanism of claim 3, further comprising two lateral grooves formed within the communication device for permitting the positioning blocks to urge thereon.
